(19) United States
(12) Patent Application Publication
(10) Pub. No.: US 2008/0232236 A1
(43) Pub. Date: Sep. 25, 2008

(54) METHOD AND APPARATUS FOR CHANNEL ESTIMATION OF OFDM WITH FREQUENCY INSERTED PILOTS

(75) Inventor: Qin Liu, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/687,684

(22) Filed: Mar. 19, 2007

(51) Int. Cl. H04J 11/00

(52) U.S. Cl. 370/208

(57) ABSTRACT

In an OFDM system having guard intervals interposed between symbols or frames, and having pilot signals distributed within the symbols or frames, a method for channel estimation is provided. The method comprising the steps of: in the time domain, performing an operation to obtain only a set of received pilots; and sectionalizing or subdividing the set of received pilots into a plurality of sub-sections; whereby a refined channel estimation is obtained on a sub-sectional basis.

### FIELD OF THE INVENTION

The present invention relates generally to channel estimation of OFDM systems, more specifically the present invention relates to a channel estimation refinement for time-varying, multipath fading channels in an OFDM system.

### BACKGROUND

Orthogonal Frequency Division Multiplex (OFDM) system is a promising communication scheme capable of achieving high data rate transmissions. However, the block structure of the OFDM such as DVB T/H makes it difficult to estimate a channel accurately. Let's look the traditional channel estimation closely. Typically, a received signal is subjected to fast Fourier transform (FFT) and the channel estimation on a specific carrier is obtained by comparing (i.e. division) the FFT with the known pilots. Interpolation is done to obtain points other than known pilot positions. This process is obviously disadvantageous in that the estimated channel only represents a smoothed version of a channel, no timing scale is achieved due to the FFT process Therefore, it is desirable to have a process to refine a time-related channel.

### SUMMARY OF THE INVENTION

In an OFDM system, pilot signals inserted in the symbol are used to provide for a channel estimation.

In an OFDM system, pilot signals inserted in the symbol are used sectional-wise to provide for at least two partial channel estimation.

In an OFDM system having guard intervals interposed between symbols or frames, and having pilot signals distributed within the symbols or frames, a method for channel estimation is provided. The method comprising the steps of: in the time domain, performing an operation to obtain only a set of received pilots; and sectionalizing or subdividing the set of received pilots into a plurality of sub-sections; whereby a refined channel estimation is obtained on a sub-sectional basis. A receiver implementing the above is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example OFDM Tx-Rx flow with guard intervals and pilots in accordance with some embodiments of the invention.

FIG. 2 is an example of a typical estimator in accordance with some embodiments of the invention.

FIG. 3 is an example of a sectionalized estimation process in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to pilot signals inserted in the symbol are used sectional-wise to provide for at least two partial channel estimation. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of pilot signals inserted in the symbol are used sectional-wise to provide for at least two partial channel estimation described herein. The non-processor circuits may include, but are not limited to, a radio receiver, a radio transmitter, signal drivers, clock circuits, power source circuits, and user input devices. As such, these functions may be interpreted as steps of a method to perform pilot signals inserted in the symbol are used sectional-wise to provide for at least two partial channel estimation pilot signals inserted in the symbol are used sectional-wise to provide for at least two partial channel estimation. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

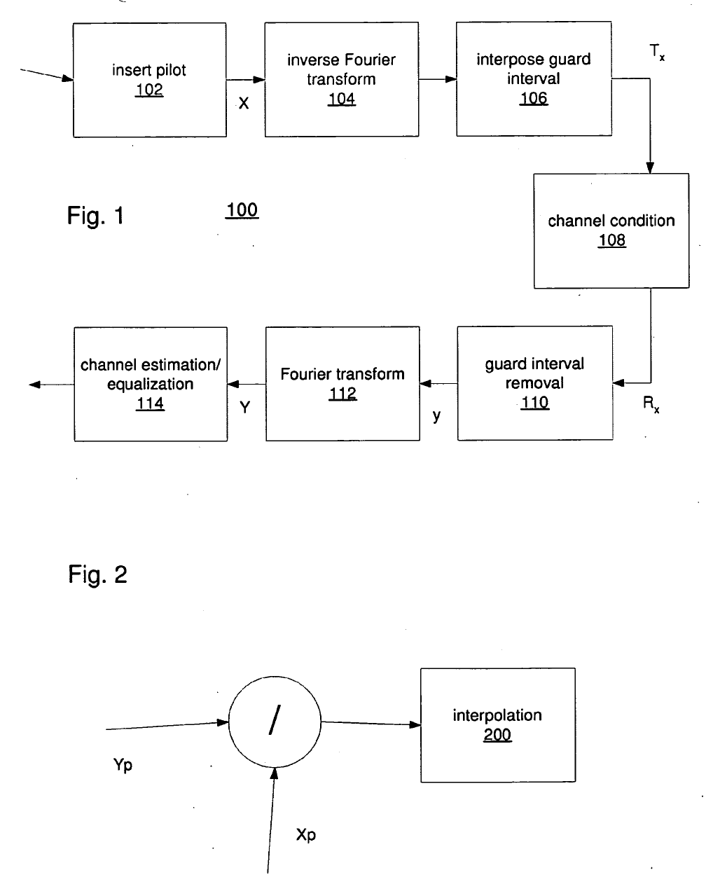

Referring to FIGS. 1-3, a typical wireless transmission system suitable for the present invention with pilot signals inserted in the symbol and being used sectional-wise to provide for at least two partial channel estimation is shown. In FIG. 1, a wireless transmission system 100 such as an orthogonal frequency division multiplex (OFDM) is shown. On the transmission side, pilots are inserted into symbol or data for transmission 102. Pilots are used for such purposes as synchronization and channel estimation at the receiver side. Symbols with the inserted pilots form transmission signal X, which are inverse Fourier transformed (F⁻¹) into the time domain 104. Guard intervals inserted or interposed within the transmission signal X 106. Symbols having interposed guard intervals are respectively transmitted in their respective channels subjecting to their associated channel condition 108. At the receiver side, after synchronization the received signal Rx has its guard interval removed 110. The guard signal free received signal y is further subjected to a Fourier transform to frequency domain 112. At this juncture, channel estimation and equalization are performed 114.

In FIG. 2, a typical channel estimator of a wireless transmission receiver suitable for the present invention is shown. The received pilot symbols Yp are divided by a native Xp (Yp/Xp) with the quotient Hp. A set of discrete point of Hp is interpolated to obtain channel estimate on the rest of the positions.

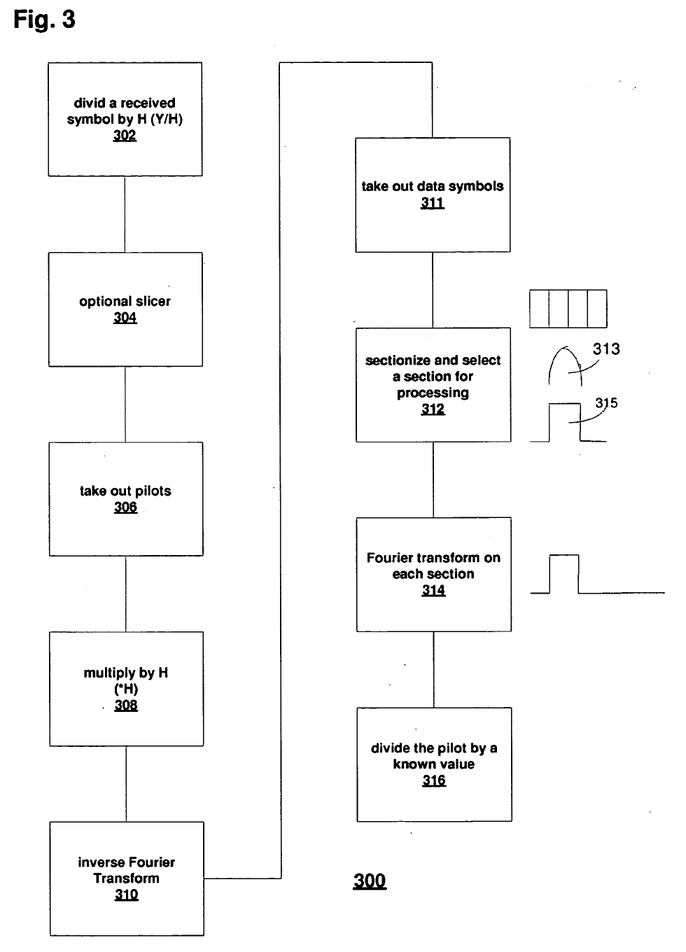

In FIG. 3, a flow chart 300 depicting the sectionization in the time domain is shown the received symbol Y is divided by H (Y/H) (Step 302). Optionally, a slicer may be provided to slice the result of (Step 304) to roughly subdivide or sort. Known pilots are taken out (Step 306). The result of the previous step is multiplied by H (*H) (Step 308). Perform inverse Fourier transform F⁻¹ into the time domain (Step 310). Take out data symbols by subtracting Rx with this transformed result in the time domain (Rx-Tnop) (Step 311). Sectionize or divide the segment into sub-segments with or without a window, and select a section for further processing (Step 312). Note that there are two types of windows in that a first type 313 wherein some signal overlaps occur due to the shape of window 313. There can also be a second type of window 315 wherein no overlap occurs. Perform respectively Fourier transform on each section but having the whole length (all sections combined) used albeit the other sections values are ignored or set to zero (Step 314). Divide the transformed, received pilot by a known channel pilot value, Yp′/Xp (Step 316). Noise reduction may be performed on each transformed section. This way, a new channel estimation that reflects this particular section or sub-division is obtained.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an OFDM system having guard intervals interposed between symbols or frames, and having pilot signals distributed within the symbols or frames, a method for channel estimation comprising the steps of:
in the time domain, performing an operation to obtain only a set of received pilots; and
sectionalizing or subdividing the set of received pilots into a plurality of sub-sections;
whereby a refined channel estimation is obtained on a sub-sectional basis.

2. The method of claim 1 further comprising the step of transforming on a sub-sectional basis.

3. The method of claim 2, wherein the step of transforming comprises using Fourier transform.

4. The method of claim 1, wherein the operation in the step of performing comprises a subtraction step.

5. In an OFDM system having guard intervals interposed between symbols or frames, and having pilot signals distributed within the symbols or frames, a receiver comprising a channel estimation adapted to implement a method for channel estimation comprising the steps of:
in the time domain, performing an operation to obtain only a set of received pilots; and
sectionalizing or subdividing the set of received pilots into a plurality of sub-sections;
whereby a refined channel estimation is obtained on a sub-sectional basis.

6. The receiver of claim 5 further comprising the step of transforming on a sub-sectional basis.

7. The receiver of claim 6, wherein the step of transforming comprises using Fourier transform.

8. The receiver of claim 5, wherein the operation in the step of performing comprises a subtraction step.
